(19) United States
(12) Patent Application Publication
(10) Pub. No.: US 2011/0231535 A1
(43) Pub. Date: Sep. 22, 2011

(54) Wireless Sensor Network

(76) Inventor: Ian Charles Starnes, Great Falls, VA (US)

(21) Appl. No.: 13/050,294

(22) Filed: Mar. 17, 2011

Related U.S. Application Data
(60) Provisional application No. 61/315,238, filed on Mar. 18, 2010.

(51) Int. Cl. G06F 15/173

(52) U.S. Cl. 709/223

(57) ABSTRACT

In a wireless sensor network, a local wireless network serves a plurality of sensor nodes. The local wireless network is reconfigurable for accepting a mobile computing device. The mobile computing device comprises a wireless network interface, such as a dongle, and is configured for selecting a set of sensor nodes for communications. The sensor network, a gateway, or a remote computing device may select the set of sensor nodes for communicating with the mobile computing device. A dongle may be provided for coupling the mobile computing device to the local wireless network. The dongle comprises a configuration unit for interfacing the mobile computing device with the local wireless network, an identification unit for storing user data used for user authentication, and a protection module for providing secure network access.

### CROSS-REFERENCE TO RELATED APPLICATIONS

This application claims priority under 35 U.S.C. 119(e) to U.S. Provisional Application Ser. No. 61/315,238, entitled “Dongle for a Wireless Sensor Network,” filed Mar. 18, 2010.

### BACKGROUND OF THE INVENTION

I. Field of the Invention

The present invention relates to a system and a method for communication in a wireless sensor network, and in particular, to such a system and method for providing local interfacing with the sensor network.

II. Description of the Related Art

A wireless sensor network comprises spatially distributed sensors configured to cooperatively monitor physical and/or environmental conditions, such as sound, vibration, pressure, motion, or pollutants. The applications of wireless sensor networks typically involve some kind of monitoring, tracking, and/or controlling. Applications for wireless sensor networks include military applications (such as battlefield surveillance) and industrial and civilian applications, including industrial process monitoring and control, machine health monitoring, environment and habitat monitoring, healthcare applications, home automation, and traffic control.

In addition to one or more sensors, each node in a sensor network is typically equipped with a radio transceiver or other wireless communications device, a small microcontroller, and an energy source, such as a battery. A sensor network normally comprises a wireless ad-hoc network, meaning that each sensor supports a multi-hop routing algorithm (i.e., several nodes may forward data packets to the base station).

In area monitoring, the wireless sensor network is deployed over a region of interest where some phenomenon is to be monitored. For example, a large quantity of sensor nodes may be deployed over a battlefield to detect enemy intrusion. When the sensors detect an event (heat, pressure, sound, light, electro-magnetic field, vibration, etc) in the field of interest, the event is typically reported to a base station, which then routes a message over the internet, a cellular network, or a satellite communication system. The data is typically transmitted to a processing center at a remote location. The processing center logs the data, performs calculations, and/or notifies personnel when predetermined conditions are met.

Depending on the particular application, different objectives require different data-propagation strategies. Such strategies depend on various operating criteria, such as the need for real-time response, event authentication, secure communications, and augmenting situational awareness by personnel operating in the region of interest. However, the network configurations that support remote processing of sensor data are not conducive to serving many of the operational needs of personnel in the region of interest.

### SUMMARY OF THE INVENTION

Aspects of the present invention solve these and other problems by providing for communicatively coupling a mobile computing device directly to a sensor network, and enabling the mobile computing device to perform command and control functions in the sensor network and collect data from the sensors.

One aspect of the present invention is directed towards methods, systems, and computer-readable media comprising program code for interfacing a mobile computing apparatus with a local wireless network serving a plurality of sensor nodes; selecting a subset of the sensor nodes for communicating with the mobile computing apparatus; and reconfiguring the local wireless network for communicating with the mobile computing apparatus.

In another aspect of the invention, a dongle is provided for coupling the mobile computing device to a wireless sensor network. The dongle comprises a configuration unit for interfacing the mobile computing device with a local wireless network serving a plurality of sensor nodes; an identification unit for storing user data used for user authentication; and a protection module for providing secure network access. A selection module is provided for selecting a set of sensor nodes for communicating with the mobile computing device. The selection module may reside on at least one of the mobile computing device, the sensor nodes, a gateway in the wireless sensor network, and a remote computing device.

### BRIEF DESCRIPTION OF THE DRAWINGS

Aspects of the invention are illustrated in the figures of the accompanying drawings, which are meant to be exemplary and not limiting, in which like references are intended to refer to like or corresponding parts, and wherein:

FIG. 1 is a block diagram of a wireless sensor network according to one aspect of the invention;

FIG. 2 is a block diagram of a dongle apparatus according to an aspect of the invention;

FIG. 3 is a block diagram of a dongle apparatus according to another aspect of the invention;

FIG. 4 is a flow diagram depicting a method in accordance with some aspects of the invention; and

FIG. 5 is a block diagram of a wireless sensor network according to another aspect of the invention

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the claimed invention. Instead, they are merely examples of systems and methods consistent with aspects related to the invention as recited in the appended claims.

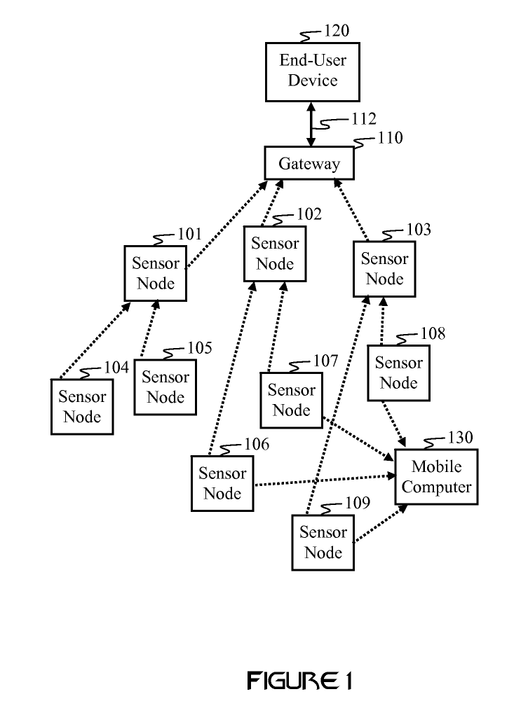

Referring to FIG. 1, sensor nodes 101-109 couple to a gateway 110 connected to a Wide Area Network (WAN) 112, such as a wired Internet backbone, a cellular network, or a satellite network. The WAN 112 connects a remote end-user unit (e.g., a computer terminal) 120 to the wireless sensor network.

Each sensor node 101-109 usually comprises a processing unit with limited computational power and limited memory (relative to the end-user device 120 or a mobile computer 130), sensors (including specific conditioning circuitry), a communication device (usually comprising radio or optical transceivers), and a power source (usually a battery). Other possible inclusions are energy harvesting modules, secondary ASICs, and/or secondary communication devices. The gateway 110 typically has much more computational, energy, and communication resources than the sensor nodes 101-109. In some aspects of the invention, the end-user device 120 is configured to raise quests for data collection, store the data received from the nodes 101-109, and process the received data.

Each of the nodes 101-109 is configured to sense environmental information, such as temperature, humidity, radio signals, light, infra-red signals, and/or sound. In a multi-hop ad-hoc network, each node is configured to transmit data to other nodes within a sensing radius. The sensor network may employ multi-hop routing, such as depicted in FIG. 1. In the conventional wireless sensor network, downstream traffic flows from the gateway 110 to all the sensor nodes 101-109, and upstream traffic flows from all the sensor nodes 101-109 to the gateway 110. Clients may poll the data from the end-user device 120, which is typically in a remote location.

In accordance with one aspect of the invention, at least one mobile computing apparatus 130 is deployed in the same region of interest as the sensors 101-109. The mobile computing apparatus 130 may comprise a laptop computer, a cellular handset, a PDA, or any other mobile communication device equipped with a micro-processor and a network interface. The mobile computing apparatus 130 is configured to interface directly with at least a sub-set of the sensor nodes 101-109 (such as sensor nodes 106-109 shown in FIG. 1) so that a user in the region of interest can communicate with the sensor nodes without going through an outside network (e.g., the WWAN 112).

In one aspect of the invention, the mobile computing apparatus 130 is configured for sending control information to the sensor nodes, such as a set of the sensor nodes 106-109. The set of sensor nodes 106-109 is selected for communicating with the mobile computing apparatus 130. For example, the mobile computing apparatus 130 may select the set of sensor nodes 106-109 from which it receives sensor data. Some sensor nodes may be selected for relaying data, whereas other sensor nodes may be selected as data sources. Some sensor nodes may be selected as both relays and data sources. The set of sensor nodes 106-109 selected by the mobile computing apparatus 130 may simply be those nodes that can communicate directly with the mobile computing apparatus 130. In one aspect of the invention, the sensor network may select which nodes communicate with the mobile computing apparatus 130. For example, the sensor nodes may perform self-selection. Alternatively, the gateway 110 and/or the end-user device 120 may select the sensor nodes 106-109 to communicate with the mobile computing apparatus 130. Selection of the sensor nodes 106-109 may depend on various factors, including, but not limited to, the geographic location of the mobile computing apparatus 130, network access permissions obtained by the mobile computing apparatus 130, and/or the sensor data requested by the mobile computing apparatus 130.

In response to the control information transmitted by the mobile computing apparatus 130, at least some of the sensor nodes (such as nodes 106-109) reconfigure their local ad-hoc network to communicate with the mobile computing apparatus 130. Such communication may comprise receiving and/or relaying information transmitted by the mobile computing apparatus 130. Such communication may comprise directly transmitting and/or relaying sensor information from at least some of the sensor nodes to the mobile computing apparatus 130. Accordingly, the mobile computing apparatus 130 is configured for receiving data transmissions from the sensor nodes 106-109. In another aspect of the invention, network access functionality is performed by any combination of the sensor nodes 106-109, the gateway 110, and the end-user device 120 for enabling the mobile computing apparatus 130 to access the network. Such network access functions may comprise identifying the mobile computing apparatus 130, authenticating the mobile computing apparatus 130, and/or allocating network resources to the mobile computing apparatus 130.

In accordance with one aspect of the invention, a dongle is coupled to the mobile computing apparatus 130. The dongle enables a user of the mobile computing apparatus 130 to have a direct line of communication with the sensors, and the sensors can communicate with the mobile computing apparatus 130 via the dongle without going through an outside network. In another aspect of the invention, software is configured to interface the mobile computing apparatus 130 to a wireless sensor network via the dongle. The software is configured for enabling the mobile computing apparatus 130 to perform command and control procedures with the sensor nodes, and the software may be configurable for enabling the mobile computing apparatus 130 to deliver the received sensor data to various applications and/or remote systems.

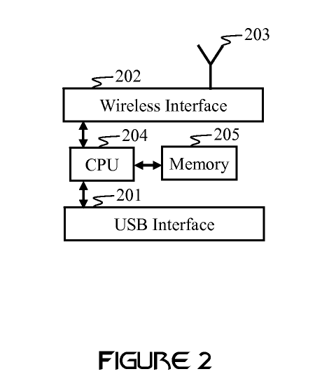

A dongle shown in FIG. 2 comprises a first interface (such as a USB interface) 201 for communicatively coupling to a mobile computing apparatus 130, such as a lap top, a PDA, a cellular handset, etc. In one aspect of the invention, the data connection and power for the dongle are supplied via the interface 201 with the mobile computing apparatus 130. A second interface 202 comprises an antenna 203, which is configured for communicatively coupling the mobile computing apparatus 130 to sensor nodes in the wireless sensor network.

A processing unit 204 is configured to provide network access negotiations such that the mobile computing apparatus can access the wireless sensor network. According to some aspects of the invention, the processing unit 204 simply listens to transmitted sensor signals. In other aspects of the invention, the processing unit 204 polls sensors for data. The processing unit 204 couples data received from the sensor network to the mobile computing apparatus. According to some aspects of the invention, the processing unit 205 is configured to couple data (e.g., sensor-control messages) from the mobile computing apparatus to sensors in the sensor network. A memory 205 is configured to store data received by either or both interfaces 201 and 202. The memory 205 may be utilized for storing instructions for the processor 204. In some aspects, the memory may store user-identification data. The memory 205 may also include instructions to be utilized or executed by the processor 204 for connecting a user to the wireless sensor network.

In reference to the present disclosure, the term “dongle” or “dongle-type” should be accorded a very broad meaning A dongle is a device that can be inserted into a connector on a computer and may operate in accordance with particular protocols to permit usage of a particular software package on the computer. Dongles are relatively small and often contained within a “connector-sized” housing.

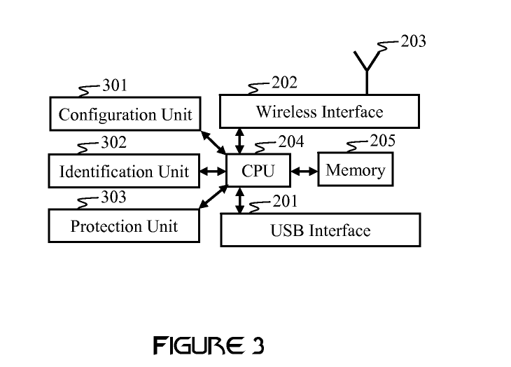

According to one aspect of the invention, the dongle further comprises any combination of components 301, 302, and 303 shown in FIG. 3. A configuration unit 301 provides for storing network configuration data, an identification unit 302 provides for recording, checking, and/or validating user data, and a protection unit 303 comprises protection mechanisms, such as firewall, virus scanner, etc. for protecting the data streams.

In one aspect of the invention, the configuration unit 301 interfaces a mobile computing apparatus with a local wireless network serving a plurality of sensor nodes. For example, the mobile computing apparatus may comprise a selection module (not shown) for selecting a set of sensor nodes to communicate with. This selection may be based on geographical proximity of the mobile computing apparatus to the set of sensor nodes. The selection may be based on signal strength received from the sensor nodes. Alternatively, other criteria may be used to select the set of sensor nodes. The configuration unit 301 is responsive to the selected sensor nodes for storing network configuration data, which is used by the mobile computing apparatus to access the local wireless network. The identification unit 302 stores user data, which the network may use to authenticate a user before allocating access to the network. The protection unit 303 is configured to provide secure network access, such as protecting the mobile computing device from malware, viruses, and exploits.

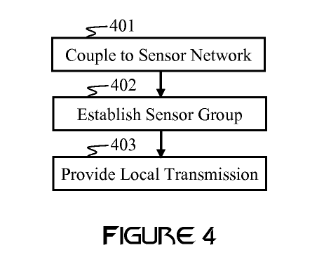

FIG. 4 is a flow diagram depicting a method in accordance with some aspects of the invention. A first step 401 provides for communicatively coupling a mobile computing apparatus to a wireless sensor network. In one aspect of the invention, the mobile computing apparatus is configurable for establishing a personal area network (PAN). A PAN may be configured to operate such that a coordinator selects one channel and periodically transmits beacons through the selected channel, and devices in a coverage area sensing the transmitted beacons join. A second step 402 provides for establishing a sensor group, the mobile computing apparatus being a kernel node of the group. The kernel node is communicatively coupled to each sensor and configured for data collecting from each sensor and, optionally, raising quests (e.g., polling each sensor). A third step 403 provides for reconfiguring at least a portion of the wireless sensor network for transmitting sensor data from the sensors to the mobile computing apparatus. One or more lead sensors may be established for aggregating data collected from other sensors. Data transmission may also include encrypting the data.

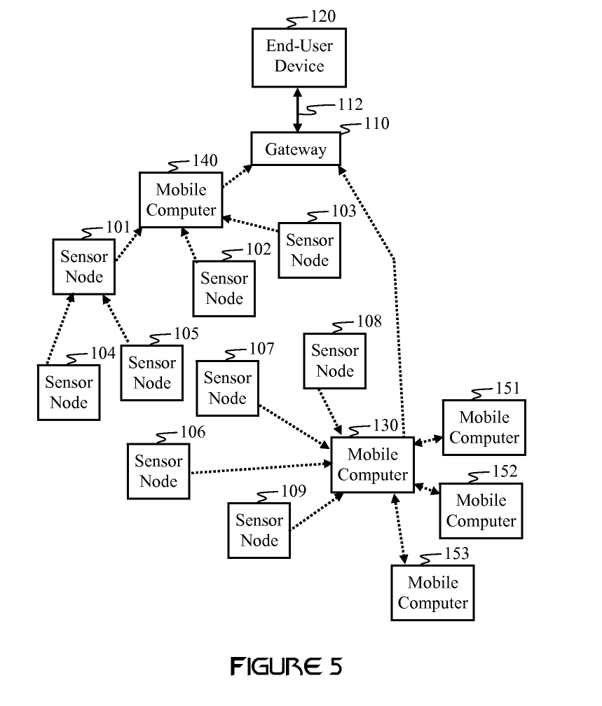

FIG. 5 is a block diagram of a wireless sensor network according to another aspect of the invention. Sensors 101-109 are deployed in a region of interest, and a plurality of mobile computing devices 130 and 140 are employed for communicating with the sensors. For example, mobile computing device 140 functions as a hub for sensors 101-105 and mobile computing device 130 functions as a hub for sensors 106-109.

In accordance with one aspect of the invention, a user of mobile computing device 140 distributes a plurality of sensors (e.g., sensors 101-105), which are then managed by the mobile computing device 140. Similarly, sensors 106-109 are distributed by a user of the mobile computing device 130, and those sensors 106-109 are managed by the mobile computing device 130. The sensors 101-109 may communicate with the gateway 110, or the sensors 101-109 may just communicate with the computing devices 130 and 140.

In another aspect of the invention, a mobile computing device, such as device 130, may function as a hub for both the sensors 106-109 and a plurality of other computing devices 151-153. For example, computing devices 151-153 may include mobile computing devices of other users in the region of interest, a local command center, peripheral computer equipment, other mobile computing devices functioning as hubs for other sensors, access points to other networks (e.g., local area networks or wide area networks), repeaters, or any combination thereof.

The foregoing description of the specific aspects reveals the general nature of the invention so that others can, by applying knowledge within the skill of the relevant art(s), readily modify and/or adapt for various applications such specific aspects, without undue experimentation, without departing from the general concept of the present invention. Such adaptations and modifications are therefore intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant arts.

1. In a wireless sensor network, a method comprising:
interfacing a mobile computing apparatus with a local wireless network serving a plurality of sensor nodes;
selecting a set of sensor nodes from the plurality of sensor nodes for communicating with the mobile computing apparatus; and
reconfiguring the local wireless network for communicating with the mobile computing apparatus.

2. The method recited in claim 1, wherein the mobile computing apparatus is configured for sending control information to the set of sensor nodes.

3. The method recited in claim 2, wherein reconfiguring is responsive to the control information.

4. The method recited in claim 1, wherein interfacing comprises at least one of identifying the mobile computing apparatus, authenticating the mobile computing apparatus, and allocating network resources to the mobile computing apparatus.

5. The method recited in claim 1, wherein selecting is performed by at least one of the mobile computing apparatus, the plurality of sensor nodes, a gateway coupled to the wireless sensor network, and an end-user device coupled to the wireless sensor network via a wide area network.

6. The method recited in claim 1, wherein selecting comprises selecting at least one of the plurality of sensor nodes as a data source and selecting at least one of the plurality of sensor nodes as a relay.

7. The method recited in claim 1, wherein the mobile computing apparatus comprises a dongle for interfacing with the local wireless network.

8. In a wireless sensor network, a mobile computing device comprising:
a dongle for coupling with the mobile computing device, the dongle comprising:
a configuration unit for interfacing the mobile computing apparatus with a local wireless network serving a plurality of sensor nodes;
an identification unit for storing user data used for user authentication; and
a protection module for providing secure network access; and
a selection module for selecting a set of sensor nodes for communicating with the mobile computing apparatus.

9. The device recited in claim 8, wherein the configuration unit is configured for sending control information to the set of sensor nodes.

10. The device recited in claim 8, wherein the identification unit is configured for performing at least one of identifying the mobile computing device, authenticating the mobile computing device, and allocating network resources to the mobile computing device.

11. The device recited in claim 8, wherein the selection module is configured for selecting at least one of the set of sensor nodes as a data source and selecting at least one of the set of sensor nodes as a relay.

12. A computer program residing on one or more computer-readable media, comprising:
a client-side configuration source-code segment for interfacing a mobile computing apparatus with a local wireless network serving a plurality of sensor nodes;
a node-selection source code segment configured for selecting a set of sensor nodes from the plurality of sensor nodes for communicating with the mobile computing apparatus; and
a network configuration source-code segment for reconfiguring the local wireless network for communicating with the mobile computing apparatus.

13. The computer program recited in claim 12, wherein the client-side configuration source-code segment is configured for sending control information to the set of sensor nodes.

14. The computer program recited in claim 13, wherein the network configuration source-code segment resides on the plurality of sensor nodes, and is responsive to the control information.

15. The computer program recited in claim 12, wherein client-side configuration source-code segment is configured for at least one of identifying the mobile computing apparatus, authenticating the mobile computing apparatus, and allocating network resources to the mobile computing apparatus.

16. The computer program recited in claim 12, wherein the node-selection source code segment resides on at least one of the mobile computing apparatus, the plurality of sensor nodes, a gateway coupled to the wireless sensor network, and an end-user device coupled to the wireless sensor network via a wide area network.

17. The computer program recited in claim 12, wherein node-selection source code segment is configured for selecting at least one of the plurality of sensor nodes as a data source and selecting at least one of the plurality of sensor nodes as a relay.
